(19) United States
(12) Patent Application Publication
(10) Pub. No.: US 2024/0149453 A1
(43) Pub. Date: May 9, 2024

(54) Method of Controlling a Robot And a Robot Control System

(71) Applicant: ABB Schweiz AG, Baden (CH)

(72) Inventors: Roger Kulläng, Västerås (SE); Anders Ekelund, Göteborg (SE)

(21) Appl. No.: 18/549,952

(22) PCT Filed: Mar. 16, 2021
(86) PCT No.: PCT/EP2021/056645

§ 371 Date: Sep. 11, 2023

(51) Int. Cl. B25J 9/16

(52) U.S. Cl. CPC B25J 9/1671

(57) ABSTRACT

The invention is concerned with a robot control system and a method of controlling a robot where the robot control system includes a human-machine interface; a real robot control environment including a real robot and a real robot controller controlling the real robot and a cloud-hosted robot control environment including a virtual robot controller, which is a replica of the real robot controller, where the human-machine interface is configured to transfer a robot change instruction from a user to the cloud-hosted robot control environment, the virtual robot controller is configured to validate the robot change instruction and the real robot controller is configured to apply the validated robot change instruction when controlling the real robot.

### TECHNICAL FIELD

The present disclosure relates to a method of controlling a robot as well as to a robot control system.

### BACKGROUND

With the introduction of cloud computing, robot control software can be placed in the cloud. This is for instance discussed in US 2019/0022856. It is also relatively easy for a user to change software in the cloud. Thereby local processing can also be reduced.

It is also known to provide a digital twin for a robot controller. A digital twin is in this case a virtual robot controller that is a replica of a real robot controller. Through the provision of a digital twin, which may be provided in the cloud, it is possible to perform simulations without the need of extensive software and processing resources locally. The placing of a digital twin in the cloud is for instance described by Li et al. in “Digital twin-based control approach for industrial cloud robotics”, Proceedings of the ASME 2019 14th International Manufacturing Science and Engineering Conference MSEC2019. Jun. 10-14, 2019.

However, although it is important that software development is simplified in the above described manner, it is at the same time important that software changes are not frivolously introduced in a real robot controller. A real robot can exert considerable mechanical forces and it is therefore important that the operation caused by such changes is as expected.

There is therefore a need for enabling the provision of changes in robot control software in a user-friendly way while ensuring that the operation is as expected.

### SUMMARY

One objective of the invention is therefore to allow software changes of robot controller software to be made in a user-friendly way while at the same time ensuring that the operation is as expected.

According to a first aspect there is presented a method for control of a real robot, the method comprising:
transferring, by a human-machine interface, a robot change instruction from a user to a cloud-hosted robot control environment, the cloud-hosted robot control environment comprising a virtual robot controller, which virtual robot controller is a replica of a real robot controller in a real robot control environment;
validating, by the virtual robot controller, the robot change instruction; and
applying, by the real robot controller, the validated robot change instruction when controlling an associated real robot.

According to a second aspect, there is provided a robot control system comprising
a human-machine interface;
a real robot control environment comprising a real robot and a real robot controller controlling the real robot; and
a cloud-hosted robot control environment comprising a virtual robot controller, which is a replica of the real robot controller,
where the human-machine interface is configured to transfer a robot change instruction from a user to the cloud-hosted robot control environment, the virtual robot controller is configured to validate the robot change instruction and the real robot controller is configured to apply the validated robot change instruction when controlling the real robot.

The human-machine interface may be an interface of the user to the cloud-hosted robot control environment. It may also be provided in the cloud-hosted robot control environment. Alternatively, the human-machine interface may be an interface of the user to the real robot control environment, which may likewise be provided in the real robot control environment.

The human-machine interface may additionally be a web-based human-machine interface. As an alternative it may be provided by a robot application running on a user terminal, in which case it would not be provided in the cloud-hosted robot control environment or the real robot control environment.

The validating may be carried out automatically by the virtual robot controller when it obtains or receives the robot change instruction. The validating may comprise investigating a changed robot operation caused by the robot change instruction. The validating may furthermore comprise comparing the changed robot operation caused by the robot change instruction with a quality criterion and determining that the changed robot operation is satisfactory if the quality criterion is fulfilled. The robot change instruction may thereby be validated by the virtual robot controller if the quality criterion is fulfilled. The quality criterion may additionally be a safety criterion, in which case robot operator safety is considered.

The investigation of the changed robot operation may furthermore involve running through an operation ordered or influenced by the robot change instruction and assessing that the operation is satisfactory, where an ordering of the operation may be an instruction directly ordering a robot controller to perform the operation, such as to move the robot, and the instruction influencing the operation may be a parameter or boundary setting that has an impact on the operation. The validating may additionally involve investigating operational margins. The validating may thus be a validation that the real robot is able to and does operate as planned. The validating may for instance comprise an investigation that a robot arm remains within a robot cell and/or does not bump into any obstacles when moving in the robot cell. The validation may also comprise an investigation that Input/Output (I/O) signals are correctly set and that the real robot does not enter a singularity.

The comparison of the changed robot operation with a quality criterion may more particularly involve comparing a virtual physical quantity of a robot arm with a corresponding physical quantity threshold and validating the robot change instruction in case the threshold remains on the same side of the threshold as before the change in operation caused by the robot change instruction, where the physical quantity may be position. However also other physical quantities are possible such as speed, acceleration, force or momentum.

The transferring of the robot change instruction by the human-machine interface may be made to the virtual robot controller of the cloud-hosted robot control environment.

It is additionally possible that the cloud-hosted robot control environment comprises a version-controlled database, which database may comprise different versions of robot control software for operating the real and virtual robot control software.

When there is a version-controlled database in the cloud-hosted robot control environment, the transferring of the robot change instruction by the human-machine interface may be made to the version controlled database for the robot change instruction to be included in a version of the robot controller software for the real and virtual robot controllers. This version may furthermore be a new version that is to replace a current version being currently run by the real robot controller. It is additionally possible that the applying of the validated robot change instruction is made through the real robot controller applying the new version of the robot controller software.

According to the first aspect, the method may furthermore comprise receiving, by the real robot controller in the real robot control environment after the validating of the changed robot operation by the virtual robot controller, the validated robot change instruction from the cloud-hosted robot control environment for being applied when controlling the real robot.

According the second aspect, the real robot controller may be configured to receive, after the validating of the changed robot operation by the virtual robot controller, the validated robot change instruction from the cloud-hosted robot control environment for being applied when controlling the real robot.

In case the robot change instruction is transferred by a human-machine-interface for the user to the real robot control environment, the method according to the first aspect may further comprise sending, by the human-machine interface, a received robot change instruction to the real robot controller for application when controlling the real robot and synchronizing the operation of the real robot controller with the operation of the virtual robot controller after the validation of the robot change instruction.

In the same case in the robot control system according to the second aspect, the human-machine interface may be configured to send a received robot change instruction to the real robot controller for application when controlling the real robot and the real robot controller may be configured to synchronize its operation with the operation of the virtual robot controller after the validation of the robot change instruction.

The real robot control environment may comprise a communication entity providing communication between the cloud-hosted robot control environment and the real robot control environment.

In case the robot change instruction is transferred by a human-machine interface for the user to the real robot control environment, this communication entity may be used for transferring the robot change instruction to the cloud-hosted robot control environment. It may also be used for synchronisation of the operation of the real robot controller with the operation of the virtual robot controller.

In case the robot change instruction is transferred by a human-machine interface for the user to the cloud-hosted robot control environment, the real robot controller may receive the validated robot control instruction from the cloud-hosted robot control environment via the communication entity.

The real robot control environment may comprise a private data network to which the real robot controller is connected. If the human-machine interface is an interface to the real robot control environment, it may additionally be an interface for the user to the private data network.

The communication entity may be a dedicated communication interface of the real robot controller, which interface is configured to provide direct communication between the real robot controller and the cloud-hosted robot control environment. The dedicated communication interface may be a wireless interface, such as an interface for Wi-Fi or mobile communication. Alternatively, the dedicated communication interface may be a wired interface, The dedicated communication interface may be a part of the real robot controller.

Alternatively, the communication entity may be a shared communication interface, such as a gateway configured to provide communication between the cloud-hosted robot control environment and the real robot control environment. Also, the gateway may be connected to the private data network. The gateway may also exist together with one or more dedicated communication interfaces in the real robot control environment. The gateway may be an edge gateway or a gateway communicating with the cloud-hosted robot control environment via Wi-Fi or mobile communication.

The various entities in the cloud-hosted robot control environment such as the virtual robot controller, the version-controlled database and/or the human-machine interface, may be realized through data centre resources, such as processing resources and data storage resources.

The real robot controller may likewise be realized through a processor and a data storage with computer program instructions that, when executed by the processor, implements the operation of the real robot controller.

The human-machine interface may likewise be realized through a processor and a data storage with computer program instructions that, when executed by the processor, implements the human-machine interface.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a diagram schematically illustrating a robot control system comprising a cloud-hosted robot control environment with a first human-machine interface and a virtual robot controller as well as a real robot control environment with a second human-machine interface and a real robot controller;

FIG. 2 is a diagram schematically illustrating some components of the second human-machine interface;

FIG. 3 is a diagram schematically illustrating some components of the real robot controller;

FIG. 4 is a flowchart schematically illustrating a method of controlling a real robot;

FIG. 5 is a diagram schematically illustrating validation of changes in a virtual robot controller before application to a real robot;

FIG. 6 is diagram schematically illustrating storing of changes in a version-controlled database before the validation of changes is performed;

FIG. 7 is a diagram schematically illustrating a push to the real robot controller via an edge gateway; and

FIG. 8 is a diagram schematically illustrating the performing of synchronisation of changes in the real robot control environment with changes in the cloud-hosted robot control environment after virtual robot controller validation of changes.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

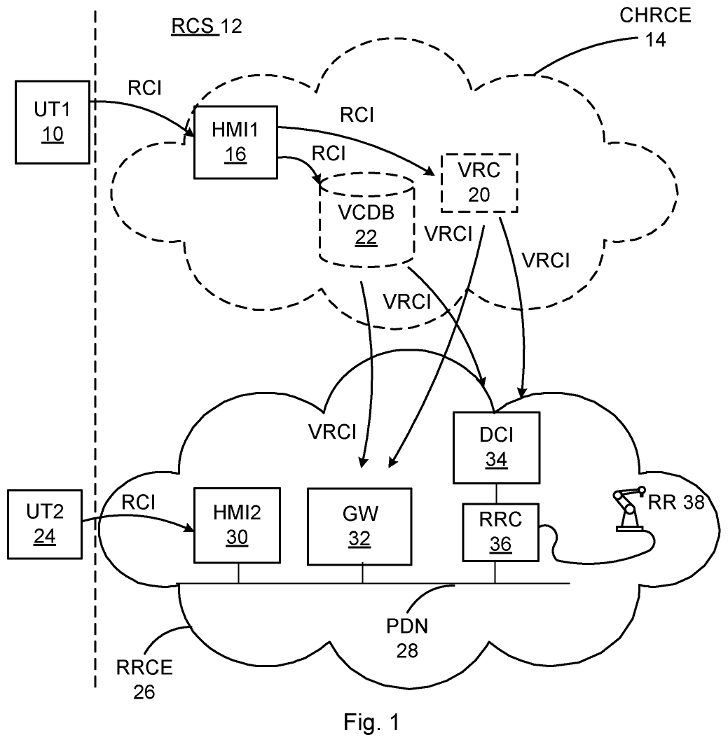

FIG. 1 is a diagram schematically illustrating a robot control system RCS 12 comprising a cloud-hosted robot control environment CHRCE 14 and a real robot control environment RRCE 26. In order to enable user access to the cloud-hosted robot control environment 14, the robot control system 12 comprises a first human-machine interface HMI1 16, which as an example is provided in the cloud-hosted robot control environment 14. In order to allow a user access to the real robot control environment 26, the robot control system 12 comprises a second human-machine interface HMI2 30, which in this case is also placed in the real robot control environment 26. These HMIs 16 and 30 are in the present example provided as web-based interfaces. They may thus be reached using a web browser in a user terminal, for instance through employing (Uniform Resource Locators) URLs. This is exemplified by the first HMI1 16 being reached by a first user terminal UT1 10 and the second HMI2 30 being reached by a second user terminal UT2 24, where in these cases the human-machine interfaces 16 and 30 are thus reached via web browsers (not shown) in the user terminals 10 and 24. The user terminals 10 and 24 may therefore be laptop or desktop computers or even mobile terminals such as smartphones and tablets. It should also be realized that it is possible with only one human-machine interface in the robot control system 12, either the first or the second human-machine interface 16 and 30.

The real robot control environment 26 comprises a real robot controller RRC 36 and a real robot RR 38, where the real robot controller 36 controls the real robot 38. The real robot control environment 26 also comprises at least one entity or device for communication with the cloud-hosted robot control environment 14. In the example given in FIG. 1, it comprises two such communication entities, where one communication entity is a dedicated communication interface DCI 34 for the real robot controller 36 and another communication entity is a shared communication interface in the form of a gateway GW 32. The dedicated communication interface 34 provides an own link for a processing entity, such as the real robot controller 36, to the cloud-hosted robot control environment 14. It may be a wireless interface, such as a Wi-Fi interface, i.e. an interface operating according to an IEEE 802.11 standard, or a mobile communication interface such as an interface to a fifth-generation mobile communication system (5G). Such a wireless interface may be realised through a radio circuit with antenna(s). The dedicated communication interface 34 may as an alternative be a wired interface. The gateway 32 does on the other hand provide a shared link from the real robot control environment 26 to the cloud-hosted robot control environment 14. The gateway 32 may be a gateway using wireless communication, such as Wi-Fi or 5G, for communicating with the cloud-hosted robot control environment. Alternatively, it may be a wired gateway such as an edge gateway or edge controller.

Depending on how many processing entities there are in the real robot control environment 26, the real robot control environment 26 may also comprise a private data network, such as a Local Area Network (LAN) or a Wireless Local Area Network (WLAN). In the example given in FIG. 1, the second human-machine interface 30, the real robot controller 36 and the gateway 32, which is an edge gateway, are connected to a private data network PDN 28, while the dedicated communication interface 34, which is a wireless interface, is connected to the real robot controller 36. Here it should be realized that the dedicated communication interface 34 may actually be a part of the real robot controller 36.

It should also be realized that it is possible with several real robot controllers in the real robot control environment 26, in which case each such robot controller may be connected to the private data network and/or equipped with a dedicated communication interface. If there are several real robot controllers, the real robots controlled by them may also be placed in different robot lines and there may additionally be one or more real Programmable Logic Controllers (PLC) connected to the private data network 28, each set to control the real robot controllers of a robot line.

The second human-machine interface 30 may be realized based on a processing entity, such as a processor acting on computer instructions, for instance computer instructions in a program memory. As such it may be realized as a separate computer connected to the private data network 28. However, it may as an alternative be realized as a part of another processing entity connected to the private data network 28. It may for instance be realized as a part of the real robot controller 36 or the gateway 32, where a processor of the processing entity acts on computer instructions that implement the second human-machine interface 30, which processing entity and computer program code implementing the human-machine interface may, as was discussed earlier, be invoked by the previously mentioned URL.

The cloud-hosted robot control environment 14 in the example shown in FIG. 1 comprises a virtual robot controller VRC 20 where the virtual robot controller 20 is a replica of the real robot controller 36. It is additionally possible that there is a virtual robot. A virtual robot may be realized through dynamic and kinematic models of the real robot 38. These models can with advantage be combined with the virtual robot controller 20. There is furthermore an optional version-controlled database VCDB 22 comprising different versions of robot control software used by the real robot controller 36 for controlling the real robot 38 and replicated by the virtual robot controller 20. If there are several real robot controllers in the real robot control environment 26, there may also be more virtual robot controllers in the cloud-hosted robot control environment 14, where each virtual robot controller corresponds to a real robot controller. If the real robot control environment 26 comprises real PLCs, then the cloud-hosted robot control environment 14 may also comprise corresponding virtual PLCs.

It should here be realized that the human-machine interfaces may be provided in applications instead of being web based, in which case they may be provided through robot applications running in the user terminals 10 and 24.

Furthermore in FIG. 1 there is shown a robot change instruction RCI being sent from the first user terminal 10 to the first human-machine interface 16 and from there to the virtual robot controller 20 as well as to the version-controlled database 22. A robot change instruction RCI is likewise shown as being sent from the second user terminal 24 to the second human-machine interface 30. Finally validated robot change instructions VRCIs are shown as being sent from the virtual robot controller 20 to the gateway 32 and dedicated communication interface 34 as well as from the version-controlled database 22 to the gateway 32 and the dedicated communication interface 34. These instructions RCI and VRCI will be described in more detail shortly.

The cloud-hosted robot control environment 14 may be realized using resources in a data centre provided by a cloud provider, which resources may comprise processing or computing resources and data storage resources.

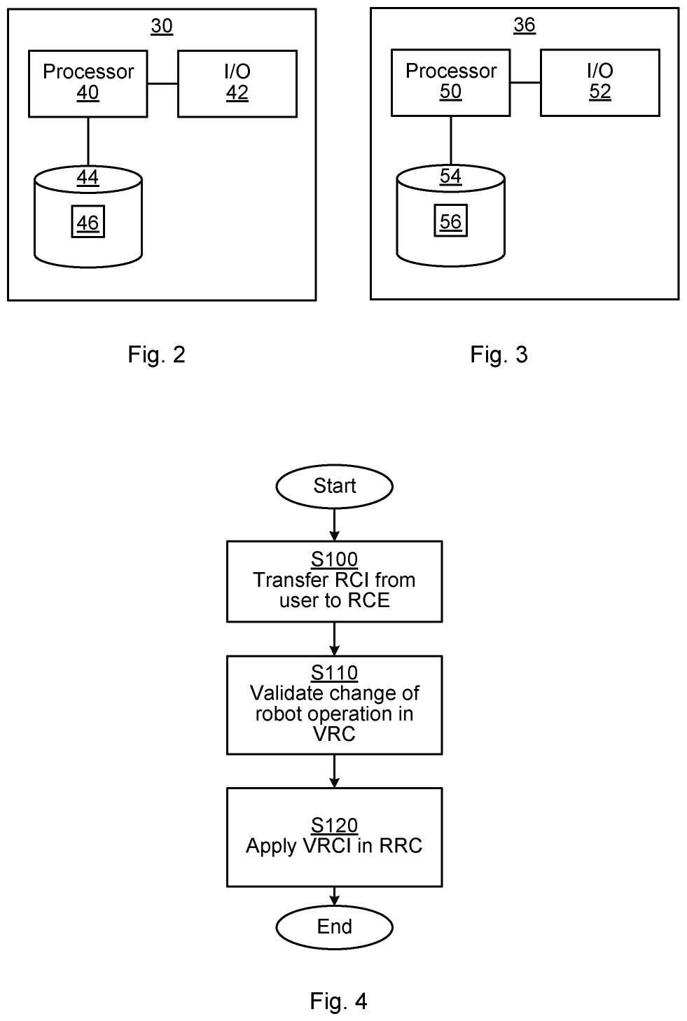

FIG. 2 is a diagram schematically showing one simplified realization of the second human-machine interface 30. There is a processor 40 and a data storage 44 with computer program instructions 46 that, when executed by the processor 40, implements the second human-machine interface 30. There is also an input/output (I/O) interface 42 for communication with user terminals, other entities on the private data network 28 as well as possibly also with the cloud-hosted robot control environment 14.

FIG. 3 is a diagram schematically showing one simplified realization of the real robot controller 36. There is a processor 50 and a data storage 54 with computer program instructions 56 that, when executed by the processor 50, implements the operation of the real robot controller 36. There is also an input/output (I/O) interface 52 for communication with the private data network 28.

There exist different HMI applications for robot controllers. These have traditionally been developed as stand-alone applications that will only run on a specific computer platform using an operating system developed for stationary computers. Furthermore, often such traditional interfaces also require a physical network connection to a real robot controller.

One such traditional interface is also the interface to a virtual robot controller that runs on a desktop PC, which virtual robot controller is a digital twin of a real robot controller.

Many handheld devices capable of displaying a human-machine interface are today using wireless communication technologies. While it would be technically feasible to hook up a robot controller to a wireless network for access to the human-machine interface, chances are that a thin device such as a phone or tablet cannot run the traditional human-machine interface applications, since these thin devices are usually using other types of operating systems that are particular for wireless devices. A solution for this is to create a web-based human-machine interface directly on the real robot controller or to create dedicated apps for each target human-machine interface platform. However, it is not necessarily a good idea to hook up all human-machine interface devices to the real robot control environment due to cyber security risks. It is often desirable to limit the attack vector to the real robot control environment to a minimum. The allowing of any device with a generic stationary or wireless device operating system to access the real robot control environment for displaying human-machine interfaces may be a less desirable alternative.

As was mentioned earlier, FIG. 1 schematically shows a robot control system 12 comprising a cloud-hosted robot control environment 14 and a real robot control environment 26. It is in many cases of interest to allow all robot controllers in the real robot control environment 26 to connect to the cloud-hosted robot control environment 14. The connection may be achieved, either using the shared or dedicated communication interface, where a dedicated communication interface provides a direct connection towards a cloud endpoint. The connection may be secure and encrypted and the network traffic may also avoid interfering with other traffic on the private data network 28.

Since robot controllers may have a cloud connection, a web interface can be created on the cloud, providing controller access to anyone with a web-capable device such as a phone, tablet, augmented reality device-, virtual reality device or Personal Computer (PC). Through such web access operators of the robot control system can be online users and need thus not be offline users that are directly connected to the robot control system without the use of Internet.

Furthermore, any device would be capable of communicating and controlling a web-hosted digital virtual robot controller, providing a similar human-machine interface experience across devices.

Through providing a cloud-hosted robot control environment it is thereby possible to allow multiple users to access this robot control environment, possibly simultaneously and thereby to collaborate on the same robot project.

The virtual robot controller 20 may as was also mentioned earlier, be an exact replica of the real robot controller 36. It may be used by various applications for offline robot programming, simulation, education and many other tasks.

The virtual robot controller 20 may be built on the same codebase as the real robot controller 36. Thereby correctness of the results can be guaranteed.

Just like the real robot controller, the virtual robot controller will run code written by the end-user in order to perform its tasks. This code may be written in a full-featured proprietary language, such as the language RAPID developed by ABB.

The virtual robot controller can thus run arbitrary code. Just like on the real robot controller, this code can access both the private data network as well as any locally mounted disks accessible by the user. It is thereby possible that unsafe code is placed in the virtual robot controller, such as harmful code or code leading to undesired or unsafe operation.

There is therefore a need for allowing a user to change the code used in the robot control system in a simple while at the same time ensuring the quality of the operation.

In order to address this issue aspects of the invention propose the use of a cloud-hosted robot control environment where users can run one or more virtual robot controllers and where changes are only implemented in the real robot control environment after being validated in the cloud-hosted robot control environment.

Different ways of operating the robot control system that achieve the above-mentioned objective will now be described with reference being made to FIG. 4, which shows a flow chart of a method of controlling the real robot 38.

The real robot controller 36 may initially operate the real robot 38 using an old or current version of robot control software. A user may then want to implement a change in this robot control software, which change may be a single change or the change to a new or next version of the robot control software. The change may more particularly be a change of robot configuration or robot operation.

The method therefore starts with transferring S100, by a human-machine interface, a robot change instruction RCI from a user to the cloud-hosted robot control environment 14, where the robot change instruction RCI may be an instruction causing a change in the operation of the real robot 38 in relation to a current operation, such as a change in the movement of the real robot 38 in relation to a current movement, where the current movement may be the movement caused by a current version of the robot control software. The robot change instruction RCI may be a change to the robot program (operational data), such as a change to an instruction to move the robot. However, it may also be robot configuration, such as the configuration of I/O parameters, networking including firewalls and user management etc. which are used for commissioning of the robot.

The transferring or conveying of the robot change instruction RCI may be made by the first human-machine interface 16 or the second human-machine interface 30. In case the transfer is made by the first human-machine interface 16, it may receive the robot change instruction RCI from the first user terminal 10 and forward this robot change instruction RCI to another entity in the cloud-hosted robot control environment 14, such as to the virtual robot controller 20 or the version-controlled database 22. In case the transfer is made by the second human-machine interface 30, it may receive the robot change instruction RCI from the second user terminal 24 and forward the robot change instruction RCI to the real robot controller 36 as well as to the cloud-hosted robot control environment 14. In relation to the forwarding to the cloud-hosted robot control environment 14, the second human-machine interface 30 may more particularly forward the robot change instruction RCI to the version-controlled database 22 and/or the virtual robot controller 20. The forwarding may additionally be made via a communication entity in the real robot control environment 26, which may be either the gateway 32 or the dedicated communication interface 34.

After the robot change instruction RCI has been conveyed to the cloud-hosted robot control environment 14, the virtual robot controller 20 validates S110 the robot change instruction RCI. In order to do this, the virtual robot controller 20 may obtain the robot change instruction RCI from the version-controlled database 22 if it has not already received it from the human-machine interface 16 or 30.

The validating may be carried out automatically by the virtual robot controller when it obtains or receives the robot change instruction RCI. The validating may involve investigating a change in an operation of the robot that is caused by the robot change operation. This may involve running through an operation ordered or influenced by the robot change instruction and assessing that the operation is satisfactory, where an ordering of the operation may be an instruction directly ordering the robot controller to perform the operation, such as to move the robot, and the instruction influencing the operation may be a parameter or boundary setting that has an impact on the operation. The validating may additionally involve comparing operational margins. The validating may be a validating that the real robot is able to and does operate as planned. The validating may for instance comprise an investigation that a robot arm remains within a robot cell or does not bump into any obstacles. It may also be an investigation that Input/Output (I/O) signals are correctly set and that the real robot does not enter in a mechanical singularity. It is also possible that the change in robot operation that is caused by the robot change instruction is presented for the user for allowing the user to confirm the validation of the robot change instruction.

The virtual robot controller may compare the changed robot operation with a quality criterion and determine that the changed robot operation is satisfactory if the quality criterion is fulfilled. The robot operation may for instance be the moving of a robot arm along a robot path and the quality criterion may be that the robot arm does not occupy positions along the path that are forbidden, such as positions corresponding to the arm bumping into other objects or boundaries of the cell where the robot is placed. The comparison of the changed robot operation with a quality criterion may more particularly involve comparing a virtual physical quantity of the robot arm with a corresponding physical quantity threshold and validating the robot change instruction in case the threshold remains on the same side of the threshold as before the change in operation caused by the robot change instruction. The threshold is thus not crossed, but the physical quantity remains above or below it. The physical quantity may be position. However also other physical quantities are possible such as speed, acceleration, force or momentum. The quality criterion may additionally be a safety criterion, in which case robot operator safety is considered.

After the validation the virtual robot controller 20 may make a setting that the robot change instruction has been validated in the version-controlled database 22.

After the validation, the real robot controller 36 also applies S120 the validated robot change instruction VRCI when operating the associated real robot 38.

In case the virtual robot controller 20 validated a robot change instruction RCI received via the first human-machine interface 16, the validated robot change instruction VRCI may be sent from the cloud-hosted robot control environment 14 to the real robot control environment 26 via the gateway 32 or dedicated communication interface 34. The validated robot change instruction VRCI may then be sent from the virtual robot controller 20 or from the version-controlled database 22. A validated robot change instruction VRCI being sent from the version-controlled database 22 may then be sent as a part of a new or next version of the robot control software to be used by the real robot controller 36. The real robot controller 36 may thus replace the current robot control software version with a new or next robot control software version, where the whole or at least a part of the new or next robot control software version has been validated.

If instead the robot change instruction RCI was received by the second human-machine interface 30, then the virtual robot controller 20 or the version-controlled database 22 may send a message to the real robot controller 36 that the robot change instruction RCI that is already present in the real robot controller 36 has been validated. The real robot controller 36 may then continue and apply the thus validated robot change instruction in the control of the real robot 38, which may be done through synchronising the change in operation of the real robot controller 36 with the change in operation of the virtual robot controller 20. In all cases the change in operation caused by the robot change instruction RCI is not used in the control of the real robot 38 until the robot change instruction RCI has been validated by the virtual robot controller 20, which validation may involve determining that an operation caused by the robot change instruction meets the quality criterion.

It can thus be seen that it is possible for a user to implement changes in the robot control software in a simple way, while at the same time ensuring that the operation in the real robot control environment is satisfactory, e.g. that the operation is in accordance with the user intention.

It is thus possible for a user to quickly make changes in a safe, virtual robot control environment provided by the cloud-hosted robot control environment and these changes may then be pushed to the real robot control environment after they have been validated. It may additionally be possible to use a virtual controller from any platform.

Now a number of examples of how validation can be carried out will be given.

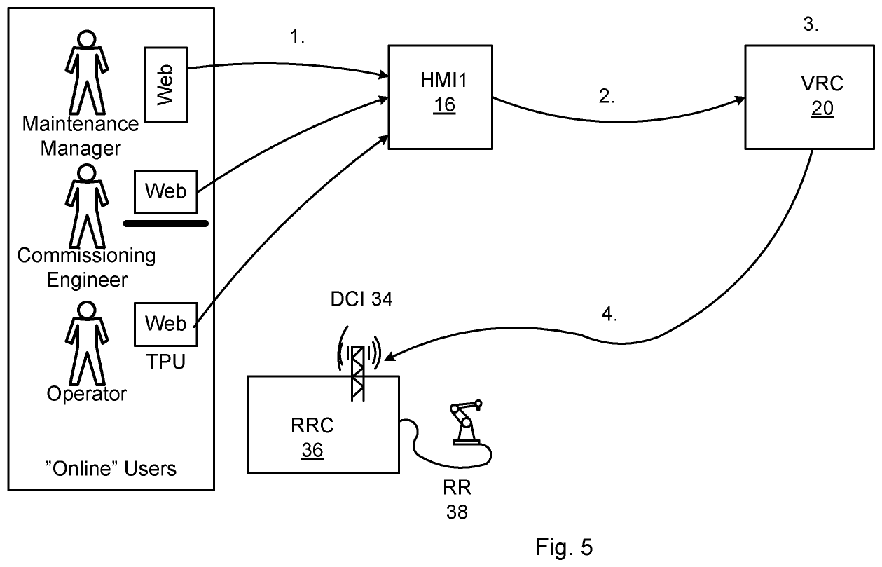

FIG. 5 shows validation of changes in the virtual robot controller 20 before application to the real robot 38 for a robot change instruction received via the first human-machine interface 16 and without the use of the version-controlled database. Three examples of an online user are shown; a maintenance manager using a web browser to connect to the first human-machine interface 16, a commissioning engineer using a web browser to connect to the first human-machine interface 16 and an operator using a web browser to connect to the first human-machine interface 16, where the web browser used by the operator may be a part of a Teach Pendant Unit (TPU) application. As web browsers are used, the first human-machine interface 16 may in this case also be a front-end Web HMI. As can be seen, the following sequence of events takes place:

1. A user makes a change to the robot configuration/program in the first human-machine interface 16. 2. Changes are sent to the virtual robot controller 20 in the cloud-hosted robot control environment. 3. Changes are validated by the virtual robot controller 20. 4. The validated changes are sent from the virtual robot controller 20 to the real robot controller 36 via the dedicated communication interface 34 and applied to the real robot 38, where the dedicated communication interface 34 in this example is a part of the real robot controller 36.

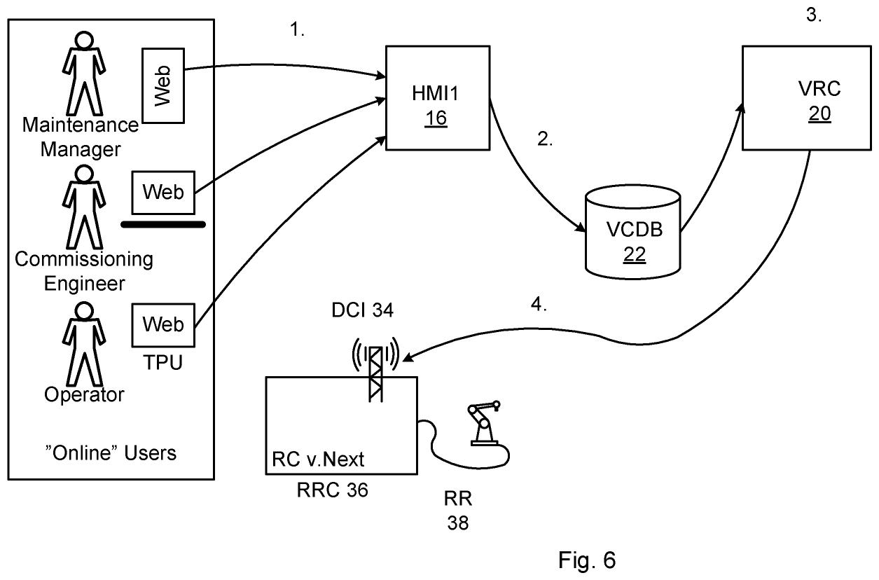

FIG. 6 shows validation of changes in the virtual robot controller 20 before application to the real robot 38 for a robot change instruction received via the first human-machine interface 16, where the robot change instruction is a part of a software version to be implemented in the real robot controller 36. The same three exemplifying users are also shown. As can be seen, the following sequence of events takes place:

1. A user makes a change to the robot configuration/program in the first human-machine interface 16. 2. Changes are sent to the version-controlled database 22 for inclusion in the new or next version of the robot control software. 3. Changes are validated by the virtual robot controller 20. Here it is possible that all changes in the new version compared to the current or old version are validated. 4. Validated changes are then sent from the virtual robot controller 20 to the real robot controller 36 in the real robot control environment via the dedicated communication interface 34, where the dedicated communication interface 34 can be a part of the real robot controller 36. The real robot controller 36 then applies the changes on the real robot 38. It is possible that the whole new version is first validated and then applied. Put differently, it is possible that no changes are made in the real robot controller 36 until the whole new software version has been validated.

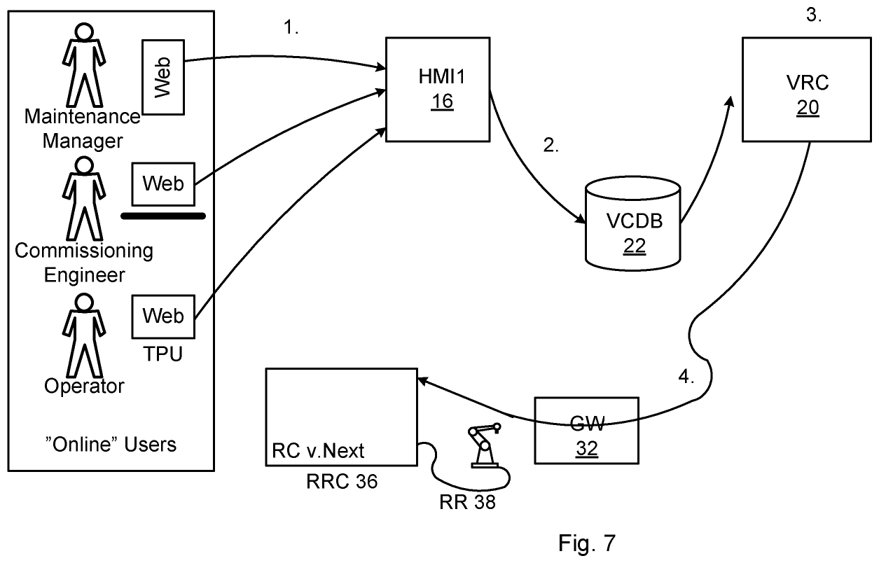

FIG. 7 shows validation of changes in the virtual robot controller before application to the real robot 38 for a robot change instruction received via the first human-machine interface 16, where the robot change instruction is again a part of a new or next software version to be implemented in the real robot controller 36 and the gateway 32 is used for communication between the two robot control environments. The three exemplifying users remain the same. As can be seen, the following sequence of events takes place:

1. A user makes a change to the robot configuration/program in the first human-machine interface 16. 2. Changes are sent to the version-controlled database 22 for inclusion in the new or next version of the robot control software. 3. Changes are validated by the virtual robot controller 20. 4. Validated changes are then sent from the virtual robot controller 20 to the real robot controller 36 via the gateway 32. The real robot controller 36 then applies the changes on the real robot 38, where again it is possible that the validated robot change instruction is sent from the version-controlled database 22 instead or that the whole new version is first validated and then applied.

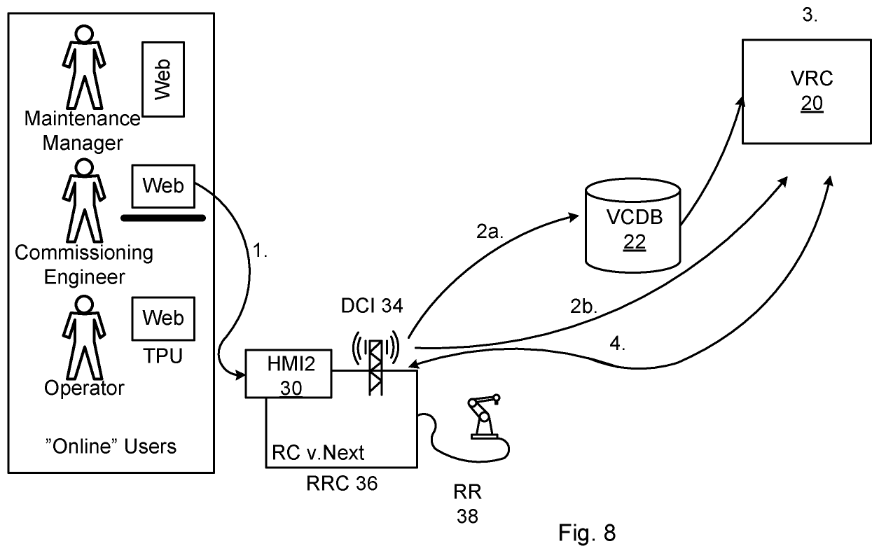

FIG. 8 shows validation of changes in the virtual robot controller 20 before application to the real robot 38 for a robot change instruction received via the second human-machine interface 30. The three users remain the same. The second human-machine interface 30 is in this case a Local Web User Interface (UI). Furthermore, the second human-machine interface 30 may in this case be a part of the real robot controller 36 as may the dedicated communication interface 34. As can be seen, the following sequence of events takes place:

1. A user makes a change to the robot configuration/program of the real robot controller 36 via the second human-machine interface 30. 2. Changes are sent to the version-controlled database 22 (2a) or to the virtual robot controller 20 (2b) via the dedicated communication interface 34 of the real robot controller 36. If the changes are sent to the version-controlled database 22, the virtual robot controller may obtain them from the database 22. 3. Changes are then validated by the virtual robot controller 20. 4. After the validation, the operation of the real robot controller 36 is synchronized with the operation of the virtual robot controller 20. The real robot controller 36 may also be notified of the validation by the virtual robot controller 20 or the version-controlled database 22. Here it should be realized that the changes and the notification could be sent via the gateway 32 instead of via the dedicated communication interface 34.

The present invention has a number of advantages apart from those already mentioned.

The entire robot controller is not run in the cloud infrastructure; only the configuration and program for the robot are hosted in the cloud and a Web-based HMI may be provided towards them. All robot motion control and collection of sensor data as well as all execution databases are still hosted in the physical or virtual robot. The virtual robot can simulate what a physical robot will do, but the simulation results cannot be directly transferred to the physical machine.

No process templates need to be used. It is possible to start with an empty robot program or to generate a program automatically from a Computer Aided Design (CAD) template.

The HMI for the robot controller may be web-based and cloud hosted. Since the HMI may be cloud-hosted, user experience and security improvements/features can easily be deployed without affecting the real robot controller i.e. they only affect the cloud platform until after validation.

The HMI for the robot controller can be made consistent across devices independent of form factor and it may also be independent of the operating system platform.

There is no need to connect with a physical cable to the robot controller to access the features.

The virtual robot controller has the same interface as the real robot controller and since it is cloud-hosted, it can be made accessible at all times for simulation and offloading computational tasks from the real robot controller. It is thus possible to run simulations and make analyses on the digital twin. These simulations and analyses may additionally be made on historical versions of the virtual robot controller using historical versions of the robot control software.

Existing apps could be modified to benefit from the cloud provided contents, including the digital twin in the cloud, which also allows the provision of an always-up-to-date virtual replica of the production equipment.

The virtual robot controller 20 may be sandboxed (isolated) from the real robot controller 36 as well as from optional other virtual robot controllers in the cloud-hosted robot control environment 14 and corresponding real robot controllers in the real robot control environment 26. Thereby the end-user may be protected from data leaks. However, also the real robot controller 36 may be protected from running potentially hostile code. Thereby it is possible to securely host virtual robot controllers that still allow potentially hostile code to execute inside them, as well as to securely host virtual devices that are not originally built to be hosted in a shared cloud-environment.

Isolation could be either on the tenant-level (an individual organization purchasing the service), or per individual user.

The virtual robot controllers can be created as replicas of real robot controllers, continuously kept updated. The synchronization could be either directly from the real robot controller to the cloud-hosted virtual robot controller using the dedicated communication interface, or through the gateway on the private data network that will in turn communicate with the real robot controller.

The virtual robot controller can be accessed from multiple platforms, such as existing simulation and robot control applications, from a mobile app, or from a web application.

The cloud-hosted robot control environment could be extended to support other virtual equipment, such as a virtual PLCs, where a change instruction to a real PLC may be validated by a virtual PLC before being implemented by the real PLC.

The vertical replica can be used as a non-destructive environment to make changes to the real production environment formed by the real robot control environment, allowing a user to test changes before pushing them to production. By integrating a version-control system, it is possible to keep track of changes over time, as well as allowing rollbacks.

The virtual replica can be very easily cloned, in order to execute long-running experiments, machine learning or other optimization algorithms in a dedicated virtual copy of the production environment formed by the real robot control environment. Another benefit is to be able to run comparison studies between the current state of the production environment and previous versions, measuring e.g. cycle time degradation.

The cloud can also host many analytics functions and optimization services, that will be easily integrated in the cloud and enrich the user experience. Updates on the cloud contents can be done without affecting the software on the real robot controller, making it possible to do “continuous deployment” on new user experience and security features and also deployments with limited scopes (beta solutions for some targeted users and region based updates, etc.)

It is possible that the second human-machine interface can still be hosted in the real robot control environment even though the first human-machine interface is used. The second human-machine interface may be provided in the real robot controller in case of troubleshooting or loss of cellular or wireless network connectivity.

The existing human-machine interface applications can be modified to be empowered with the cloud provided contents, including the digital twin in the cloud. This would make these apps more powerful while connected. It is also possible to gradually move users towards a cloud platform instead of a “big bang” replacement of the human-machine interfaces.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

1. A method for control of a real robot, the method comprising:
transferring, by a human-machine interface, a robot change instruction from a user to a cloud-hosted robot control environment, the cloud-hosted robot control environment having a virtual robot controller, which virtual robot controller is a replica of a real robot controller in a real robot control environment;
validating, by the real robot controller, the robot change instruction; and
applying, by the virtual robot controller, the validated robot change instruction when controlling an associated real robot.

2. The method according to claim 1, wherein the validating comprises comparing a changed robot operation caused by the robot change instruction with a quality criterion and determining that the changed robot operation is satisfactory if the quality criterion is fulfilled, thereby obtaining the validated robot change instruction.

3. The method according to claim 1, wherein the transferring of the robot change instruction by the human-machine interface is made to the virtual robot controller of the cloud-hosted robot control environment.

4. The method according to claim 1, wherein the transferring of the robot change instruction by the human-machine interface is made to a version controlled database in the cloud-hosted robot control environment for the robot change instruction to be included in a version of robot controller software for the real and virtual robot controllers.

5. The method according to claim 1, further comprising receiving, by the real robot controller in the real robot control environment after the validating of the changed robot operation by the virtual robot controller, the validated robot change instruction from the cloud-hosted robot control environment for being applied when controlling the real robot.

6. The method according to claim 5, wherein the real robot control environment comprises a private data network to which the real robot controller is connected, and the receiving is made via a gateway of the real robot control environment that is connected to the private data network.

7. The method according to any of claim 1, further comprising sending, by the human-machine interface, the received robot change instruction to the real robot controller for application when controlling the real robot, and synchronizing the operation of the real robot controller with the operation of the virtual robot controller after the validation of the robot change instruction.

8. A robot control system comprising
a human-machine interface;
a real robot control environment including a real robot and a real robot controller controlling the real robot; and
a cloud-hosted robot control environment including a virtual robot controller, which is a replica of the real robot controller,
where the human-machine interface is configured to transfer a robot change instruction from a user to the cloud-hosted robot control environment, the virtual robot controller is configured to validate the robot change instruction and the real robot controller is configured to apply the validated robot change instruction when controlling the real robot.

9. The robot control system according to claim 8, wherein the cloud-hosted robot control environment comprises a version-controlled database, and the human-machine interface is configured to transfer the robot change instruction to the version controlled database for the robot change instruction to be included in a version of robot controller software for the real and virtual robot controllers and to instruct the virtual robot controller to validate the robot change instruction in a validation of said version of robot controller software.

10. The robot control system according to claim wherein the human-machine interface is a web-based human-machine interface.

11. The robot control system according to claim 8, wherein the human-machine interface is provided by a robot application running on a user terminal.

12. The robot control system according to claim 8, wherein the human-machine interface is an interface for the user to the cloud-hosted robot control environment.

13. The robot control system according to any of claim 8, wherein the real robot control environment comprises a private data network to which the real robot controller is connected and the human-machine interface is an interface for the user to the private data network.

14. The robot control system according to any of claim 8, further comprising a dedicated communication interface for the real robot controller and configured to provide communication between the real robot controller and the cloud-hosted robot control environment.

15. The robot control system according to any of claim 8, further comprising a gateway configured to provide communication between the cloud-hosted robot control environment and the real robot control environment.

16. The method according to claim 2, wherein the transferring of the robot change instruction by the human-machine interface is made to the virtual robot controller of the cloud-hosted robot control environment.

17. The method according to claim 2, wherein the transferring of the robot change instruction by the human-machine interface is made to a version controlled database in the cloud-hosted robot control environment for the robot change instruction to be included in a version of robot controller software for the real and virtual robot controllers.

18. The method according to claim 2, further comprising receiving, by the real robot controller in the real robot control environment after the validating of the changed robot operation by the virtual robot controller, the validated robot change instruction from the cloud-hosted robot control environment for being applied when controlling the real robot.
